(19) United States
(12) Patent Application Publication
(10) Pub. No.: US 2007/0091380 A1
(43) Pub. Date: Apr. 26, 2007

(54) Automatic generation of a quick dial reference sheet

(75) Inventors: Shirley F. Mitchell, Lexington, KY (US); Patrick L. Ransom, Lexington, KY (US); Steven A. Rice, Shelbyville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/254,462

(22) Filed: Oct. 20, 2005

(51) Int. Cl. H04N 1/00

(52) U.S. Cl. 358/440; 358/442

(57) ABSTRACT

A method for the automatic generation of a quick dial reference sheet includes associating each of a plurality of quick dial buttons of an apparatus with a respective entry of a plurality of entries in a quick dial database; defining a layout of the quick dial reference sheet to have a plurality of printable areas respectively associated with the plurality of quick dial buttons; populating each area of the plurality of printable areas in the layout of the quick dial reference sheet with a corresponding identification retrieved from a corresponding one of the plurality of entries of the quick dial database; and printing a copy of the populated layout on a sheet of media. In a further embodiment the quick dial reference sheet can be incised or perforated to a desired size.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. FIELD OF THE INVENTION

The present invention relates generally to an imaging apparatus, and more particularly to the automatic generation of a quick dial reference sheet for an apparatus having quick dial buttons, such as an all-in-one machine (AIO) having facsimile (fax) capability.

2. Description of the Related Art

In prior art, many fax machines and fax enabled AIOs have Quick Dial or One Touch Dial buttons. In most cases, there is a small piece of paper next to these buttons which is intended to serve as a reference sheet for the quick dial buttons. It is planned for the user to write the name relating to a programmed quick dial number next to the corresponding indicator on the quick dial reference sheet. Such a method is acceptable for a new machine; however, the programmed quick dial numbers quite often change necessitating an update of the quick dial reference sheet. The updating is often accomplished by erasing the name (if the name is not in ink), crossing out the name and rewriting a new name, or using some form of correction device (tape, fluid, etc.) to cover the old name and then write a new name on the correction device. None of these methods provide an acceptable way of replacing the quick dial reference sheet.

### SUMMARY OF THE INVENTION

The present invention relates to the automatic generation of a quick dial reference sheet for an apparatus having quick dial buttons, such as for example an all-in-one machine (AIO) having facsimile capability.

The present invention, in one form thereof, is directed to a method for the automatic generation of a quick dial reference sheet for use with an apparatus having a plurality of quick dial buttons programmed to perform quick dialing in a telephone system. The apparatus includes a quick dial database storing a plurality of entries, each entry including an identification and a telephone number. The method includes associating each of the plurality of quick dial buttons of the apparatus with a respective entry of the plurality of entries in the quick dial database; defining a layout of the quick dial reference sheet to have a plurality of printable areas respectively associated with the plurality of quick dial buttons; populating each area of the plurality of printable areas in the layout of the quick dial reference sheet with a corresponding identification retrieved from a corresponding one of the plurality of entries of the quick dial database; and printing a copy of the populated layout on a sheet of media.

The present invention, in another form thereof, is directed to a method for the automatic generation of a quick dial reference sheet for use with an apparatus having a plurality of quick dial buttons programmed to perform quick dial functions in a telephone system. The apparatus includes a quick dial database storing a plurality of entries, each entry including a contact name and a telephone number. The method includes associating a plurality of identifiers 1 to N with a corresponding plurality of quick dial buttons 1 to N of the apparatus; associating the plurality of identifiers 1 to N with a corresponding plurality of entries in the quick dial database; defining a layout of the quick dial reference sheet to have a plurality of printable areas 1 to N; populating each area of the plurality of printable areas 1 to N in the layout of the quick dial reference sheet with a corresponding one of the plurality of identifiers 1 to N and with a corresponding contact name from a corresponding one of the plurality of entries from the quick dial database; and printing a copy of the populated layout on a sheet of media.

The forms of the invention disclosed further include incising or perforating quick dial reference sheet to a desired size.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an apparatus used in performing the method of the present invention.

FIG. 2 is a diagrammatic depiction of the quick dial database of the apparatus of FIG. 1.

FIG. 3 is a flowchart of a method for the automatic generation of a quick dial reference sheet, in accordance with an embodiment of the present invention.

FIG. 4 is an illustration of an embodiment of a quick dial reference sheet having a plurality of printable areas, formed by the method of FIG. 3.

FIG. 5 is an illustration showing a sheet of media including the layout of the quick dial reference sheet of FIG. 4.

FIG. 6 is an illustration of another embodiment of a quick dial reference sheet having a plurality of printable areas and having a plurality of cutouts for receiving a plurality of quick dial buttons, formed by the method of FIG. 3.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

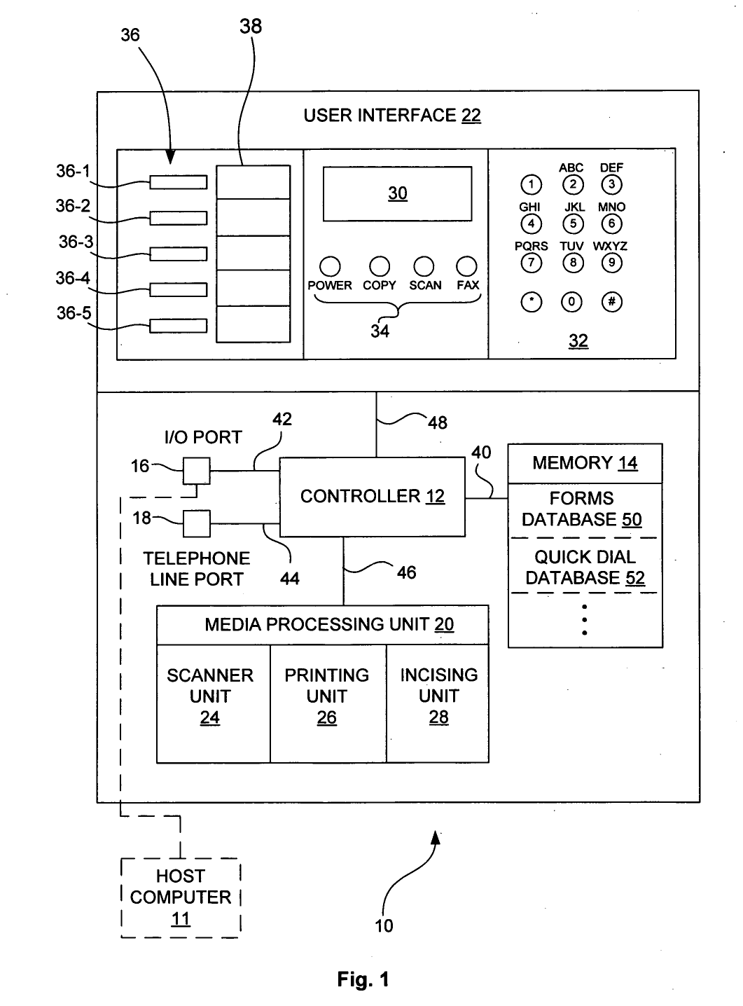

Referring now to the drawings and particularly to FIG. 1, there is shown an apparatus 10 embodying the present invention. In the present embodiment, apparatus 10 is in the form of an All-In-One machine (AIO), also sometimes referred to as a multi-function imaging apparatus, and may operate as a standalone unit that has scanning, faxing, printing, and/or incising or perforating functionality. Optionally, apparatus 10 may be configured to be communicatively coupled to an external operator console, such as a host computer 11 (shown in dashed lines).

Apparatus 10 includes a controller 12, a memory 14, an I/O (input/output) port 16, a telephone line port 18, a media processing unit 20, and a user interface 22. Media processing unit 20 may include, for example, a scanner unit 24, a printing unit 26 and an incising unit 28.

User interface 22 may include, for example, a display screen 30, a keypad 32, a set of operation buttons 34, a set of quick dial buttons 36, and a quick dial reference sheet 38. Operation buttons 34 may include, for example, a POWER button, a COPY button, a SCAN button, a FAX button, etc. for controlling various operations of apparatus 10. The quick dial buttons 36 may be individually programmed to dial a particular telephone number by a single touch of the corresponding button. In the present example, five quick dial buttons 36-1, 36-2, 36-3, 36-4 and 36-5 are arranged in a single column, however, those skilled in the art will recognize the quantity and orientation of quick dial buttons 36 may be changed from the example shown, based on design preference, requirements and/or constraints.

Controller 12 is communicatively coupled to memory 14 via a communications link 40. Controller 12 is communicatively coupled to I/O port 16 via a communications link 42. Controller 12 is communicatively coupled to telephone line port 18 via a communications link 44. Controller 12 is communicatively coupled to media processing unit 20 via a communications link 46. In turn, each of scanner unit 24, printing unit 26 and incising unit 28 is configured to communicate with controller 12 via communications link 46. Controller 12 is communicatively coupled to user interface 22 via a communications link 48. As used herein, the term “communications link” generally refers to structure that facilitates electronic communication between two or more components, and may operate using wired or wireless (e.g., infrared or r.f) technology.

Memory 14 may be, for example, a semiconductor memory, and may be used by controller 12 as general memory, as well as a memory used to establish databases, such as a forms database 50 and a quick dial database 52. Forms database 50 may be used, for example, to store general form layouts including printing and/or incising coordinates, such as those associated with quick dial reference sheet 38. Quick dial database 52 may be used, for example, to store telephone numbers and associated information, such as identifications, assigned to the quick dial buttons 36. The telephone numbers may be used, for example, for voice and/or facsimile communication over a telephone system.

In practice, I/O port 16 may include multiple communication ports that may be used to communicate with other devices, such as a computer or network. I/O port 16 may include, for example, multiple USB ports, an Ethernet port, a standard serial port, etc.

Telephone line port 18 is used to make a connection to a telephone system to facilitate voice and/or facsimile communication between apparatus 10 and another device, such as a fax machine. For example, when apparatus 10 is operating in a facsimile mode, a user may enter a facsimile telephone number via one of quick dial buttons 36, and controller 12 responds by dialing the number over telephone line port 18.

Scanner unit 24 may be used in performing faxing and copying operations. Scanner unit 24 may include, for example, one or both of a stationary scan bar and a moving scan bar, depending on the type of scanning desired or required for a particular scanning application. Some scanning apparatuses, for example, may utilize the same scanning bar to accommodate either a stationary scan bar implementation or a moving scan bar implementation. In implementations where a stationary scan bar is used, scanning occurs by feeding the sheet of media past the stationary scanner. In implementations where a moving scan bar is used, commonly called a flat bed scanner, the media sheet is typically transported to a stationary position on a document glass platen, and the sheet of media is scanned by scanning the scan bar across the stationary sheet of media. Further, in the flat bed type scanner, scanning may occur in the media feed direction, or alternatively, in a direction transverse to the media feed direction.

Printing unit 26 is used for performing printing operations. Printing unit 26 includes a print engine for forming printed text or an image on a sheet of media. The print engine may be, for example, an ink jet print engine that includes a reciprocating printhead carrier that carries one or more printheads in a print zone over the sheet of media, as is well known in the art. The reciprocating printhead carrier may carry, for example, an ink jet printhead cartridge that includes an ink supply reservoir and an ink jet printhead connected to the ink supply reservoir.

Incising unit 28 is used in performing a cutting operation. Incising unit 28 may include, for example, cutting mechanism which is selectively brought into and out of engagement with a sheet of media by an actuator. The actuator may be, for example, an electrical solenoid. One example of such a cutting mechanism, which may also be used for perforating, includes a reciprocating needle. Other known cutting devices include, for example, rotary cutters and knife cutters.

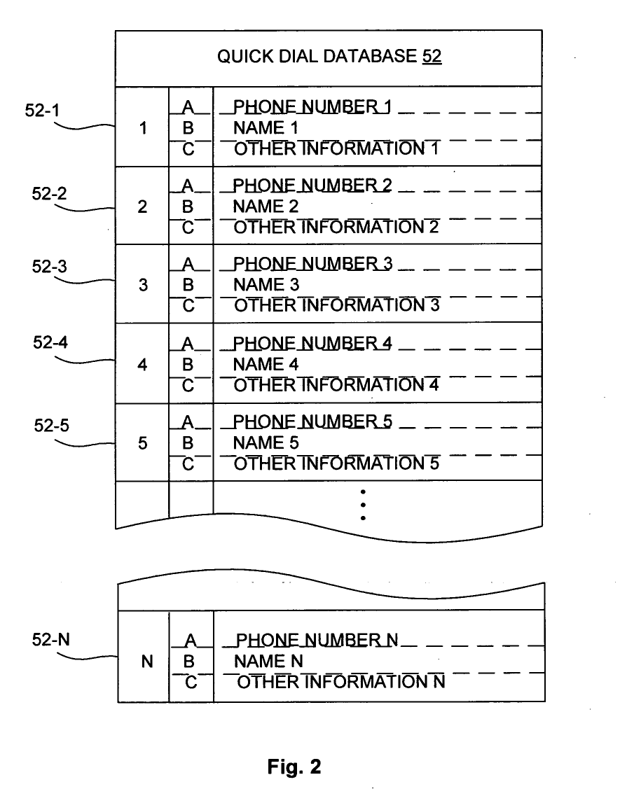

FIG. 2 is a diagrammatic representation of quick dial database 52. Quick dial database 52 includes a plurality of storage bins, individually identified as 52-1, 52-2, 52-3, 52-4, 52-5, . . . 52-N. Within each storage bin 52-1, 52-2, 52-3, 52-4, 52-5, . . . 52-N is a plurality of sub-bins. In this example, the number of sub-bins in each storage bin is three, and respectively labeled A, B and C. In this example, sub-bin A will store a telephone number, sub-bin B will store an identification, e.g., a contact name, associated with the telephone number, and sub-bin C may be used to store other associated information, such as for example, an address (physical or email), an alternative telephone number, etc. Those skilled in the art will recognize that the quantity of bins and sub-bins, and the associated memory storage space, may be selected based upon the anticipated use, memory size limitations, etc. The data may be entered into the quick dial database via the keypad 32 and/or operation buttons 34, may be downloaded from an attached host computer, entered by other means known in the art.

As an example, each of quick dial buttons 36-1, 36-2, 36-3, 36-4 and 36-5 may be individually programmed to correspond to the telephone numbers, e.g., PHONE NUMBER 1, PHONE NUMBER 2, PHONE NUMBER 3, PHONE NUMBER 4, and PHONE NUMBER 5, in each of sub-bins 52-1-A; 52-2-A; 52-3-A; 52-4-A; and 52-5-A, respectively. Each of sub-bins 52-1-B; 52-2-B; 52-3-B; 52-4-B; and 52-5-B may include a corresponding name, e.g., NAME 1, NAME 2, NAME 3, NAME 4, and NAME 5, which when a particular one of quick dial buttons 36-1, 36-2, 36-3, 36-4 and 36-5 is pressed, may be accessed and displayed on display screen 30. As a more particular example, by pressing quick dial button 36-1, NAME 1 may be displayed on display screen 30, and PHONE NUMBER 1 will be dialed. Further, each of sub-bins 52-1-C; 52-2-C; 52-3-C; 52-4-C; and 52-5-C may include other information associated with the respective button, such as for example, a button identifier, such as an icon image, e.g., number, letter or symbol, assigned to the particular button.

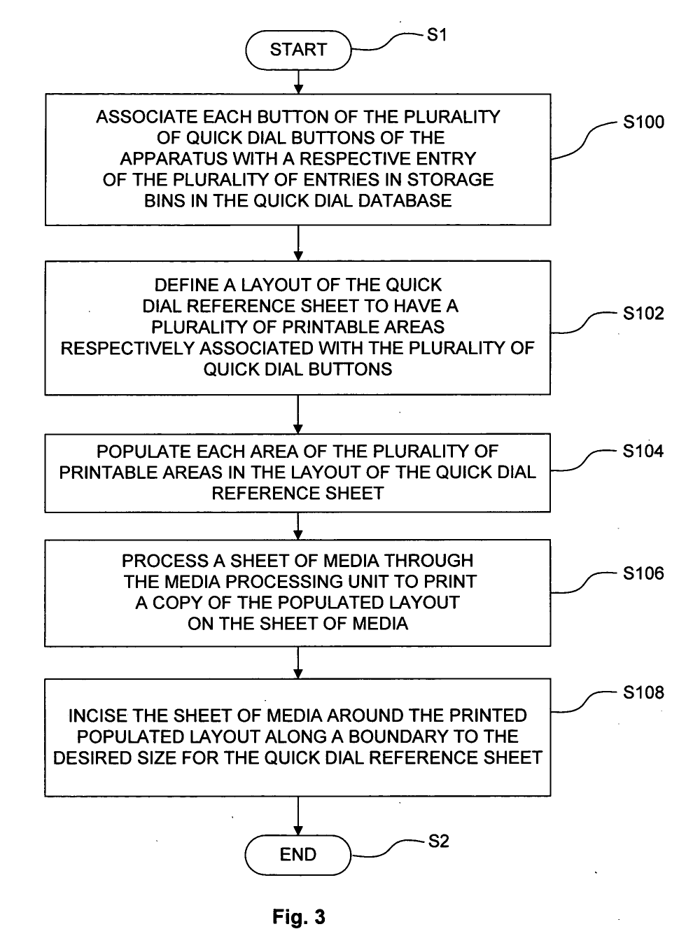

FIG. 3 is a flowchart of a method for the automatic generation of a quick dial reference sheet, such as quick dial reference sheet 38, in accordance with the present invention. The method may be implemented as a computer program, such as in firmware, hardware, or software, containing program instructions which when executed perform the various steps of the method of FIG. 3. The program may be resident in firmware or hardware associated with controller 12 of apparatus 10, so as to make the method accessible when apparatus 10 is operating in a standalone mode. Alternatively, the program may be, for example, part of a fax setup utility operating on a host connected to I/O port 16 of apparatus 10.

The automatic generation of the quick dial reference sheet may be initiated at S1 by a user entering a command by pressing a button that accesses a menu, such as for example, by pressing one or more of the buttons of keypad 32 on apparatus 10 to convey to controller 12 a selection from a menu displayed on display screen 30. Alternatively, a dedicated button may be provided, such as with operation buttons 34, if desired. As a further alternative, the command may be entered at host computer 11. The method results in the automatic generation of a quick dial reference sheet having a defined format, which is populated with identification information associated with quick dial buttons 36.

At step S100, each button 36-1, 36-2, 36-3, 36-4 and 36-5 of the plurality of quick dial buttons 36 of apparatus 10 is associated with a respective entry of the plurality of entries in storage bins 52-1, 52-2, 52-3, 52-4, 52-5 in quick dial database 52. In the example of FIG. 2, quick dial button 36-1 is associated with PHONE NUMBER 1, NAME 1, OTHER INFORMATION 1; quick dial button 36-2 is associated with PHONE NUMBER 2, NAME 2, OTHER INFORMATION 2; quick dial button 36-3 is associated with PHONE NUMBER 3, NAME 3, OTHER INFORMATION 3; quick dial button 36-4 is associated with PHONE NUMBER 4, NAME 4, OTHER INFORMATION 4; AND quick dial button 36-5 is associated with PHONE NUMBER 5, NAME 5, OTHER INFORMATION 5. The association may be implemented, for example, by an index pointer that points to a particular bin in quick dial database 52 when a particular button of the plurality of quick dial buttons 36 is selected, e.g., pushed.

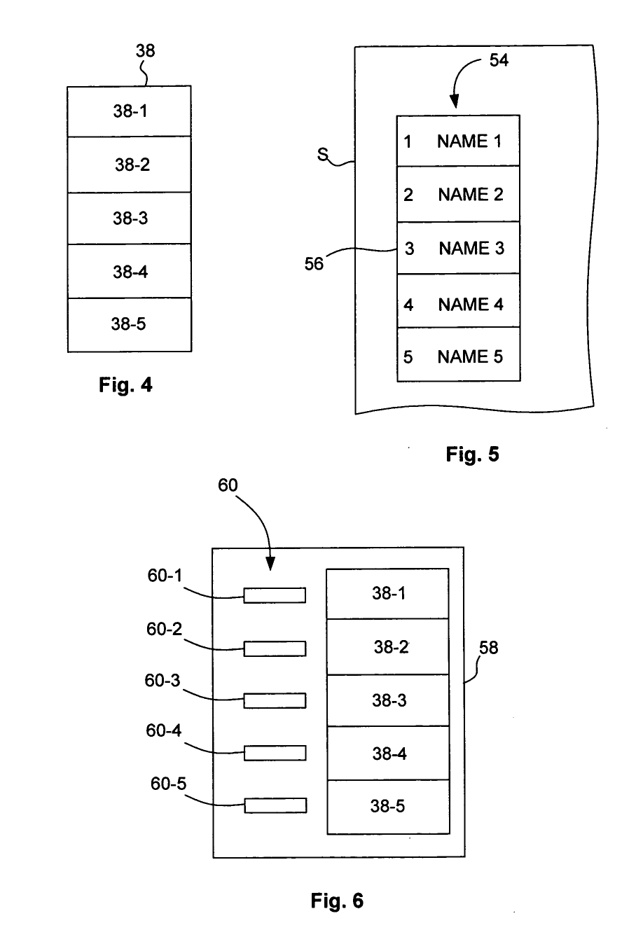

At step S102, with reference to FIG. 4, a layout of quick dial reference sheet 38 is defined to have a plurality of printable areas 38-1, 38-2, 38-3, 38-4, 38-5 respectively associated with the plurality of quick dial buttons 36. The layout may be represented digitally in memory 14. For example, printable area 38-1 corresponds to button 36-1, printable area 38-2 corresponds to button 36-2, printable area 38-3 corresponds to button 36-3, printable area 38-4 corresponds to button 36-4, and printable area 38-5 corresponds to button 36-5. Step S102 may be performed as a step preliminary to step S100, i.e., the layout may have been pre-defined and stored in forms database 50. Alternatively, the layout for quick dial reference sheet 38 may be performed at any appropriate time prior to printing quick dial reference sheet 38. If desired, the layout of quick dial reference sheet 38 may be previewed, for example, at display screen 30 of apparatus 10. In configurations including host computer 11, the layout of quick dial reference sheet 38 may be previewed at the computer monitor.

At step S104, with reference to FIG. 5, each area of the plurality of printable areas 38-1, 38-2, 38-3, 38-4, 38-5 in the layout of quick dial reference sheet 38 shown in FIG. 4 is populated, for example, with a corresponding identification, e.g., NAME 1, NAME 2, etc., telephone number, and/or other identification number, letter or symbol, retrieved from a corresponding one of the plurality of entries of said quick dial database 52 to form a populated layout 54. For example, printable area 38-1 of the layout is populated with NAME 1 from sub-bin 52-1-B of quick dial database 52, printable area 38-2 of the layout is populated with NAME 2 from sub-bin 52-1-B of quick dial database 52, printable area 38-3 of the layout is populated with NAME 3 from sub-bin 52-3-B of quick dial database 52, printable area 38-4 of the layout is populated with NAME 4 from sub-bin 52-4-B of quick dial database 52, and printable area 38-5 of the layout is populated with NAME 5 from sub-bin 52-5-B of quick dial database 52.

Also, the identification may include a cross reference identifier to the particular button of the plurality of quick dial buttons 36. For example, if button 36-1 is identified by a visual icon, such as a numeral, letter or symbol, then the identification may include both the visual icon retrieved from sub-bin 52-1-C and the NAME 1 retrieved from sub-bin 52-1-B. For example, quick dial button 36-1 may be labeled “1:” and NAME 1 may be “LEXMARK”, so printable area 38-1 is populated with “1: LEXMARK”.

At step S106, with reference to FIGS. 1 and 5, a sheet of media S is processed through media processing unit 20 to print a copy of the populated layout 54 on the sheet of media S. For example, the populated layout 54 may be printed on the sheet of media S by processing the sheet of media S through printing unit 26 to form the printed portion of quick dial reference sheet 38.

At step S108, referring to FIG. 5, the sheet of media S is incised, i.e., perforated or cut, around the printed populated layout 54 along a boundary 56 to the desired size for quick dial reference sheet 38. The incising operation may be performed by processing the sheet of media S through incising unit 28 to form quick dial reference sheet 38 as a card. For example, a perforation pattern may be defined on the sheet of media S corresponding to boundary 56 around the layout, and a perforation operation performed by incising unit 28 to separate quick dial reference sheet 38 from surplus material in the sheet of media S. The desired size may be, for example, a size for installation in the appropriate location for quick dial reference sheet 38 on user interface 22 of apparatus 10, such as for example, to the right of quick dial buttons 36-1, 36-2, 36-3, 36-4 and 36-5 as shown in FIG. 1.

It is contemplated that quick dial reference sheet 38 may take other forms, depending in part on the arrangement of the plurality of quick dial buttons 36. For example,

FIG. 6 is an illustration of a quick dial reference card 58, which includes the plurality of printable areas 38-1, 38-2, 38-3, 38-4, 38-5, and in addition, includes a plurality of cutouts 60, individually identified as cutouts 60-1, 60-2, 60-3, 60-4, and 60-5, that are sized and positioned to respectively receive quick dial buttons 36-1, 36-2, 36-3, 36-4 and 36-5. In this example, the plurality of cutouts 60 may be formed by incising unit 28 during step S1108.

Also, it is contemplated that steps S106 and S108 may be combined, such that the printing operation and the incising operation occur concurrently. The process ends at block S2.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for the automatic generation of a quick dial reference sheet for use with an apparatus having a plurality of quick dial buttons programmed to perform quick dialing in a telephone system, said apparatus including a quick dial database storing a plurality of entries, each entry including an identification and a telephone number, said method comprising:
associating each of said plurality of quick dial buttons of said apparatus with a respective entry of said plurality of entries in said quick dial database;
defining a layout of said quick dial reference sheet to have a plurality of printable areas respectively associated with said plurality of quick dial buttons;
populating each area of said plurality of printable areas in said layout of said quick dial reference sheet with a corresponding identification retrieved from a corresponding one of said plurality of entries of said quick dial database; and
printing a copy of the populated layout on a sheet of media.

2. The method of claim 1, wherein said corresponding identification includes a name.

3. The method of claim 1, further comprising incising said sheet of media to produce said quick dial reference sheet at a desired size.

4. The method of claim 3, wherein button openings are formed in said quick dial reference sheet during said incising to receive said plurality of quick dial buttons.

5. The method of claim 3, wherein said printing and said incising occur concurrently.

6. The method of claim 3, wherein said incising is one of perforating and cutting.

7. The method of claim 1, wherein said apparatus performs at least said populating and said printing by executing program instructions.

8. The method of claim 1, further comprising a user entering a command at said apparatus to initiate the automatic generation of said quick dial reference sheet.

9. The method of claim 1, wherein a computer coupled to said apparatus performs at least said populating, and said apparatus performs said printing.

10. The method of claim 9, further comprising a user entering a command at said computer to initiate the automatic generation of said quick dial reference sheet.

11. A method for the automatic generation of a quick dial reference sheet for use with an apparatus having a plurality of quick dial buttons programmed to perform quick dial functions in a telephone system, said apparatus including a quick dial database storing a plurality of entries, each entry including a contact name and a telephone number, said method comprising:
associating a plurality of identifiers 1 to N with a corresponding plurality of quick dial buttons 1 to N of said apparatus;
associating said plurality of identifiers 1 to N with a corresponding plurality of entries in said quick dial database;
defining a layout of said quick dial reference sheet to have a plurality of printable areas 1 to N;
populating each area of said plurality of printable areas 1 to N in said layout of said quick dial reference sheet with a corresponding one of said plurality of identifiers 1 to N and with a corresponding contact name from a corresponding one of said plurality of entries from said quick dial database; and
printing a copy of the populated layout on a sheet of media.

12. The method of claim 11, further comprising incising said sheet of media to produce said quick dial reference sheet at a desired size.

13. The method of claim 12, wherein button openings are formed in said quick dial reference sheet during said incising to receive said plurality of quick dial buttons.

14. The method of claim 12, wherein said printing and said incising occur concurrently.

15. The method of claim 12, wherein said incising is one of perforating and cutting.

16. The method of claim 11, wherein said apparatus performs at least said populating and said printing by executing program instructions.

17. The method of claim 11, further comprising a user entering a command at said apparatus to initiate the automatic generation of said quick dial reference sheet.

18. The method of claim 11, wherein a computer coupled to said apparatus performs at least said populating, and said apparatus performs said printing.

19. The method of claim 18, further comprising a user entering a command at said computer to initiate the automatic generation of said quick dial reference sheet.
